(19) United States
(12) Patent Application Publication
(10) Pub. No.: US 2016/0150226 A1
(43) Pub. Date: May 26, 2016

(54) MULTI-VIEW THREE-DIMENSIONAL DISPLAY SYSTEM AND METHOD WITH POSITION SENSING AND ADAPTIVE NUMBER OF VIEWS

(71) Applicant: THOMSON LICENSING, Issy de Moulineaux (FR)

(72) Inventors: Jianping SONG, Beijing (CN); wenjuan SONG, Beijing (CN); Gang CHENG, Beijing (CN)

(21) Appl. No.: 14/899,594

(22) PCT Filed: Jun. 28, 2013
(86) PCT No.: PCT/CN2013/078387

§ 371 Date: Dec. 18, 2015

(51) Int. Cl. H04N 13/04; G06T 3/40; H04N 13/02

(52) U.S. Cl. CPC H04N 13/0497; H04N 13/0402; H04N 13/0484; H04N 13/0203; G06T 3/40

(57) ABSTRACT

A multi-view three-dimensional display system and method with an adaptive number of views are described. The system includes a position sensing unit for detecting a position of an observer, a view disposing unit for determining a number of views and a view arrangement based on the position, such that only a different one of the views is provided to a viewing zone for each eye of the observer, and a multi-view display unit for displaying the number of views in accordance with the view arrangement to enable viewing of a three-dimensional image by the observer.

### TECHNICAL FIELD

The present principles relate generally to a three-dimensional multi-view display system and method, and more particularly, to a system and method with position sensing and an adaptive number of views.

### BACKGROUND

For an observer to perceive a three-dimensional (3D) image, the image seen by the left eye of the observer should be different from the image seen by the right eye of the observer. The image seen by the left eye is often referred as a left view or a left-eye image, and the image seen by the right eye is often referred as a right view or a right-eye image. In stereoscopic display systems, special filtering glasses are used so that a right-eye image is seen only by the right eye, and a left-eye image (different from the right-eye image) is seen only by the left eye. An auto-stereoscopic display allows a 3D image to be observed without the use of such filtering glasses. Instead, different viewpoints of a scene or image are provided along different directions, so that when certain different views are seen by the respective right and left eyes, 3D effect can be observed.

Different optical configurations can be used to generate the different image views in an auto-stereoscopic display. For example, a lenticular lens can be used so that respective pixel images are displayed only along certain directions for viewing. In a parallax barrier, a number of slits or windows are positioned at a front surface of a display to allow viewing of each pixel along only certain directions. Each auto-stereoscopic display has specific regions or “sweet spots”, where an observer can see different views or images for the left and right eyes, respectively, resulting in the observation of stereo vision or 3D image. Although there is some freedom of movement for the observer's head inside the sweet spot (side to side, as well as closer or farther away from the display), it is still quite restrictive because the left and right eyes are constrained to be in certain respective viewing zones or locations.

By increasing the number of display viewpoints, a multi-view display can be used to increase the extent of the region in which 3D effect can be observed. Discussions of multi-view displays can be found in various publications, such as Holliman: “3D Display Systems” (http://citeseerx,ist.psu.edu/viewdoc/summary?doi=10.1.1 1492099, 2005); Dodgson: “Analysis of the Viewing Zone of Multi-view Autostereoscopic Displays” (presented at Stereoscopic Displays and Applications XIII, Jan. 21-23, 2002, San Jose, Calif.; published in Proc. SPIE 4660); Dodgson et ale “Multi-View Autostereoscopic 3D Display” (http://citeseer.ist.psu.edu/viewdoc/summary?doi=10.1.1.42.7623, 1999); and in “Broadcast 3D) and Mobile Glasses-free Displays” (selected content from Insight Media University courses, November 2011); all of which are herein incorporated by reference in their entirety. Although a multi-view display can provide more freedom for the observer to move to the left or right, there is still an optimal viewing distance for observing stereo-vision. If the observer is positioned too close or too far from the display compared to the optimal distance, the observer may not be able to observe 3D images. This viewing limitation may be a significant disadvantage compared to existing two-dimensional (2D) displays.

SUMMARY

These and other drawbacks of the prior art are addressed by the present principles, which are directed to a multi-view three-dimensional display system and method with position sensing and an adaptive number of views.

One aspect of the present principles provides a multi-view three-dimensional display system with an adaptive number of views. The system includes: a position sensing unit for detecting a position of an observer; a view disposing unit for determining a number of views and a view arrangement based on the position, such that only a different one of the views is provided to a viewing zone for each eye of the observer; and a multi-view display unit for displaying the number of views according to the view arrangement determined by the view disposing unit to enable viewing of a three-dimensional image by the observer.

Another aspect of the present principles provides a method for displaying multi-view three-dimensional content. The method includes detecting a position of an observer; determining a number of views and a view arrangement based on the position such that only a different one of the views is provided to a viewing zone for each eye of the observer; and displaying the number of views in accordance with the view arrangement to enable viewing of a three-dimensional image by the observer.

Another aspect of the present principles provides a computer readable storage medium including a computer readable program for use in a multi-view three-dimensional display system, that when executed by a computer causes the computer to perform the following steps: detecting a position of an observer; determining a number of views and a view arrangement based on the detected position such that only a different one of the views is provided to a viewing zone for each eye of the observer; and displaying the number of views in accordance with the view arrangement to enable viewing of a three-dimensional image by the observer.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary processing system to which the present principles can be applied, in accordance with an embodiment of the present principles; FIG. 2 shows an exemplary multi-view three-dimensional display system with position sensing and an adaptive number of views, in accordance with an embodiment of the present principles;

FIG. 3 shows an exemplary method for displaying multi-view three-dimensional content using position sensing and an adaptive number of views, in accordance with an embodiment of the present principles;

FIG. 4 shows a parallax barrier used in a liquid crystal display to which the present principles can be applied, in accordance with an embodiment of the present principles;

FIG. 5 shows left and right eye viewing zones corresponding to the display of FIG. 4;

FIG. 6 shows a two-view three-dimensional display to which the present principles can be applied, in accordance with an embodiment of the present principles;

FIG. 7 shows left and right eye viewing zones corresponding to a four-view three-dimensional display to which the present principles can be applied, in accordance with an embodiment of the present principles;

FIG. 8 shows views corresponding to different viewing locations with respect to a multi-view three-dimensional display to which the present principles can be applied, in accordance with an embodiment of the present principles;

FIG. 9 shows views corresponding to different viewing locations with respect to a multi-view three-dimensional display with position sensing, in accordance with an embodiment of the present principles; and

FIG. 10 shows the views corresponding to the different viewing locations with respect to the multi-view three-dimensional display of FIG. 9 after view disposition based on position sensing, in accordance with an embodiment of the present principles.

### DETAILED DESCRIPTION

The present principles are directed to a multi-view three-dimensional display system and method with position sensing and an adaptive number of views. In one embodiment, the present principles advantageously adjust the view zone of a multi-view display by adjusting the number of views responsive to the detection or tracking of the location of an observer in front of the display.

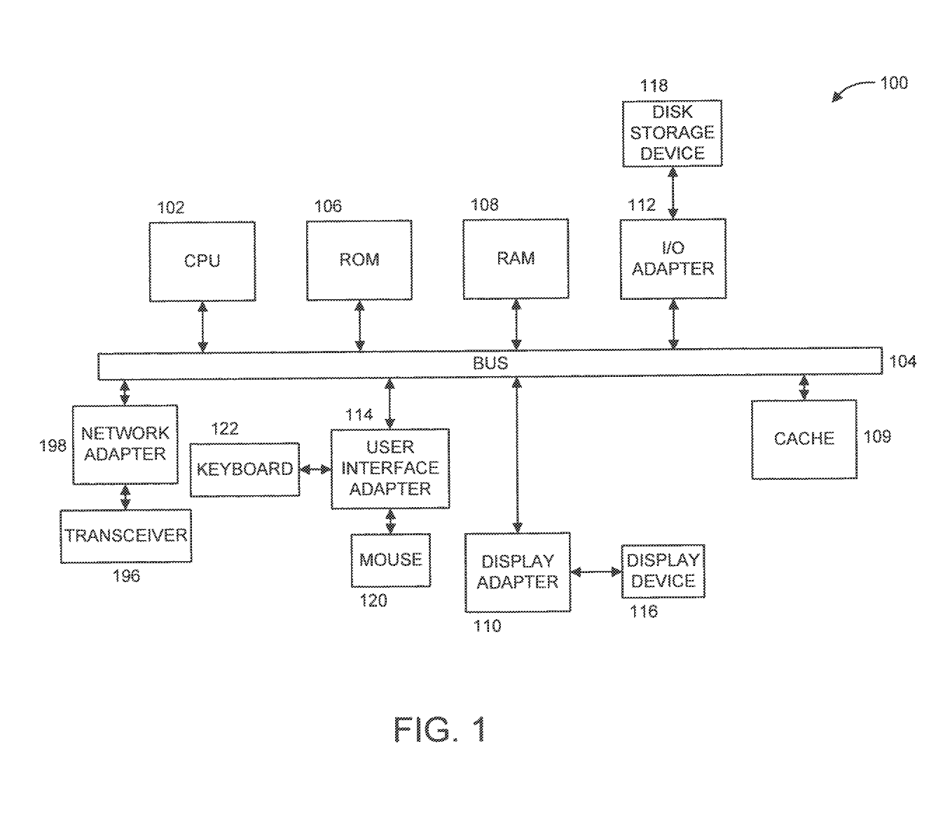

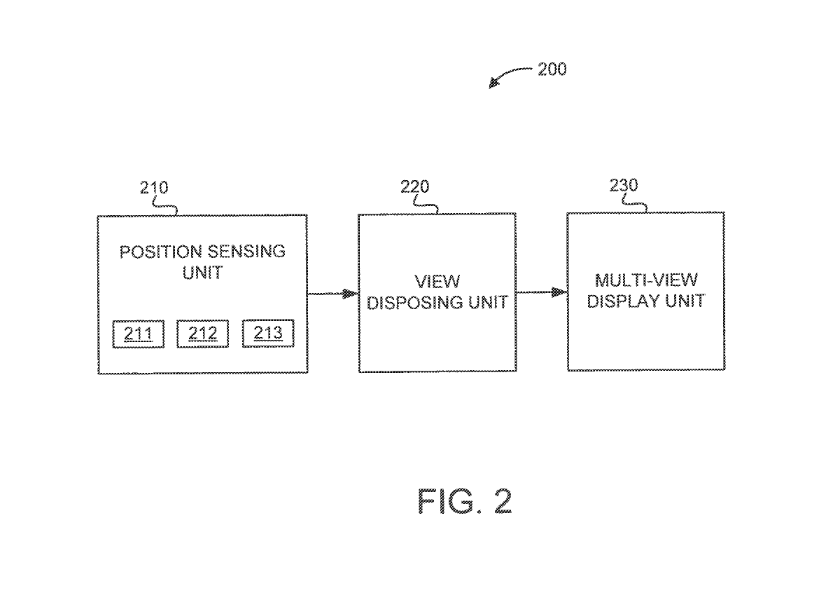

FIG. 1 shows an exemplary processing system 100 to which the present principles may be applied, in accordance with an embodiment of the present principles. The processing system 100 includes at least one processor (CPU) 102 operatively coupled to other components via a system bus 104. A read only memory (ROM) 106, a random access memory (RAM) 108, a display adapter 110, an input/output (I/O) adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A transceiver 196 is operatively coupled to system bus 104 by network adapter 198.

The processing system 100 may also include other elements (not shown), omit certain elements, as well as other variations that are contemplated by one of ordinary skill in the art given the teachings of the present principles provided herein.

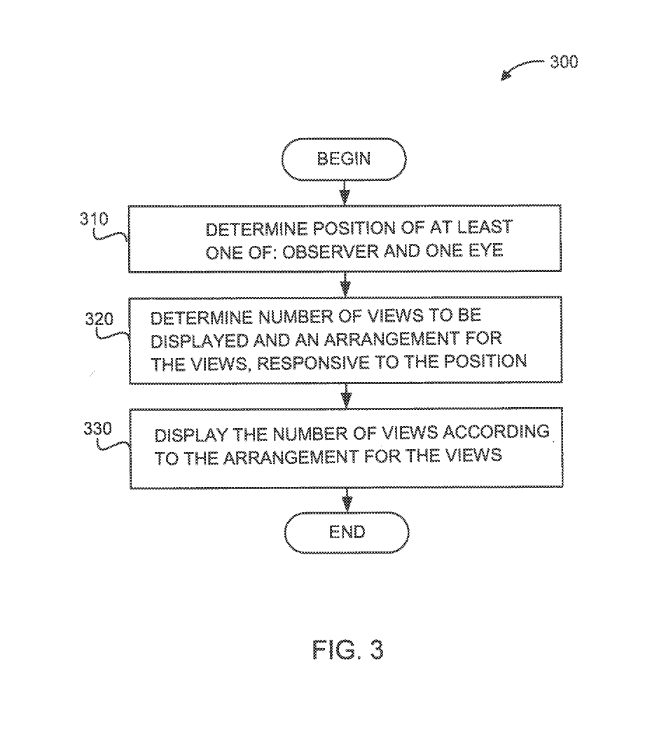

Moreover, it is to be appreciated that system 200 described below with respect to FIG. 2 is a system for implementing respective embodiments of the present principles. Part or all of processing system 100 may be implemented in one or more of the elements of system 200, and part or all of processing system 100 and system 200 may perform at least some of the method steps described herein including, for example, method 300 of FIG. 3.

FIG. 2 shows an exemplary a multi-view three-dimensional display system 200 with position sensing and an adaptive number of views, in accordance with an embodiment of the present principles. The system 200 includes a position sensing unit 210, a view disposing unit 220, and a multi-view display unit 230.

The position sensing unit 210 is configured to sense or detect the position of an observer and/or the position of at least one eye of the observer. In one embodiment, the position sensing unit 210 can include an observer image generation unit 211 configured for generating an image of the observer (e.g., by photographing the observer), and a position calculating unit 212 configured for calculating the position of the observer and/or at least one eye of the observer, from the image of the observer. In the context of the present invention, the spatial position or location of the observer and that of one or both eyes of the observer can be used interchangeably, since the positional information can be deduced from each other. Thus, depending on the specific context, subsequent references to the position of the observer can be interpreted to include the alternative of the position of one or both eyes of the observer.

As an example of determining a spatial position of the observer, the observer image generation unit 211 can include at least one of a monocular camera, stereo camera, a multi-camera, and a depth camera. It is to be appreciated that, given the teachings of the present principles provided herein, other devices and/or techniques can also be used for determining the spatial position of the observer

As another example to determine a spatial position of the observer, the position sensing unit 210 can include a distance measuring unit 213 to measure distance from the multi-view display unit 230 to the observer in general and/or to one or both eyes of the observer in particular. In one embodiment, distance information can be generated, for example, by projecting a supplementary light source onto the observer.

The view disposing unit 220 computes or determines the number of views to be displayed and disposes or arranges the views according to the position of the observer. The determination can be done based on various parameters of a given autostereoscopic display system, e.g., display screen width, optimal viewing distance and an “eye box” width (width over which an image is visible across the whole screen) and concepts such as those discussed by Dodgson, “Analysis of the viewing zone of multi-view autostereoscopic displays,” Proc. SPIE 4660 (2002), among others. The view disposing unit 220 ensures that after re-disposing or arranging the views, the left and right eyes of the observer see different views, with each eye seeing exactly only one view (that forms a stereoscopic image pair with the other eye's view) to allow stereo-vision, i.e., a three-dimensional image based on the two views, to be observed at the position of the observer. In one embodiment, the view disposing unit 220 is also responsible for enlarging the sweet spot or corresponding viewing regions for the left and right eyes for observing stereovision on using one or more techniques as described herein.

The multi-view three-dimensional display unit 230 displays images corresponding to different views to allow viewing of a three-dimensional image. In one embodiment, the multi-view three-dimensional display unit 230 can display images corresponding to at least two different viewpoints using at least one of a lenticular lens, a parallax barrier, prism arrangement, multi-projectors, a holographic device having characteristics to convert a direction of light, a directional backlight, and so forth. It is to be appreciated that the preceding list is merely illustrative and not exhaustive.

FIG. 3 shows an exemplary method 300 for displaying multi-view three-dimensional content using position sensing and an adaptive number of views, in accordance with an embodiment of the present principles.

At step 310, the position of an observer is detected or determined, for example, using the position sensing unit 210 of FIG. 2 as described above. The observer's position can refer to one or more reference points of the observer that are relevant to stereoscopic vision, including for example, the head, or one or both eyes of the observer. Of course, given the teachings of the present principles provided herein, one of ordinary skill in the art will readily determine the above and other ways for position sensing or detection.

At step 320, the number of views to be displayed and an arrangement for the views are calculated or determined responsive to, or based on the position determined at step 310. Specifically, the number of views and arrangement of the views are determined such that only a different one of the views is provided to a viewing zone for each eye of the observer.

At step 330, the resultant number of views are displayed in accordance with the arrangement of the views determined at step 320, to enable viewing of a three-dimensional image by the observer. As an example, the multi-view display unit can display images corresponding to at least two different viewpoints using one of a lenticular lens, a parallax barrier, prism arrangement, multi-projectors, a holographic device having characteristics to convert a direction of light, a directional backlight, and so forth.

Thus, as noted above, to allow viewing of a three-dimensional image without the use of filtering glasses, images having different viewpoints based on different viewing positions can be displayed and separately viewed by each eye of an observer. For example, separate images may be displayed to the left and right eyes of an observer, respectively, thereby providing a three-dimensional effect. To implement this, light emitted from each pixel of a display can be observable primarily only from a specific direction, which can be a significant difference in comparison with a two-dimensional display where pixel information for each pixel is observable from all directions. To enable the light emitted from each pixel to be observed only from a specific direction, a lenticular lens array or a parallax barrier array can be used, for example. These optical mechanisms optically divided the columns of pixels into two or more sets, each visible from particular directions.

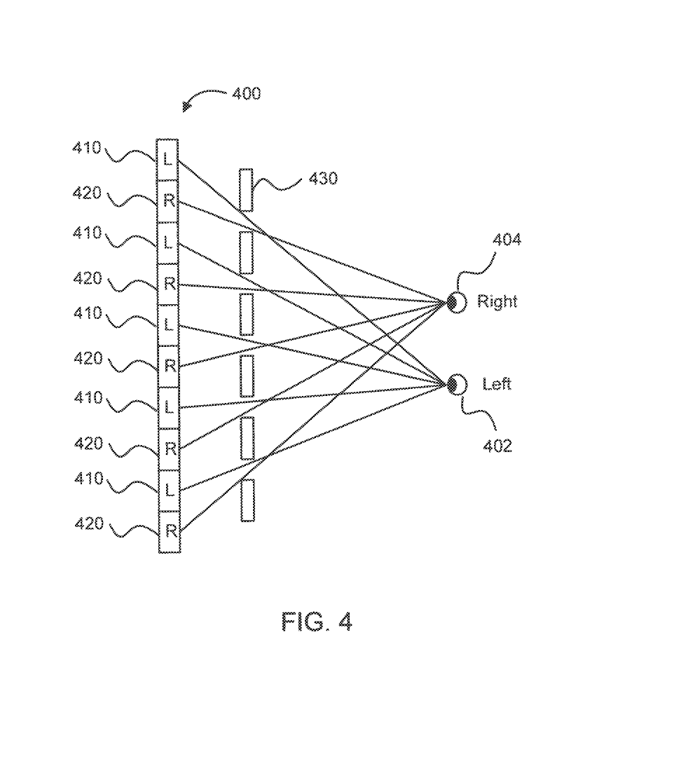

FIG. 4 illustrates a parallax barrier 430 used in a liquid crystal display (LCD) 400 to which the present principles can be applied, in accordance with an embodiment of the present principles. Both left eye images 410 and right eye images 420 are displayed on the display 400. Location 402 indicates the location of the left eye (or “left eye location 402 ”) of an observer, and location 404 indicates the location of the right eye (or “right eye location 404 ”) of the observer. The parallax barrier 430 is disposed between the locations 402 and 404 and the images 410 and 420 for refracting lights emitted from the images 410 and 420. The parallax barrier 430 is designed such that light emitted from a left eye image 410 is blocked by the parallax barrier 430 from reaching the right eye location 404, and light emitted from a right-eye image 420 is blocked by the parallax barrier 430 from reaching the left eye location 402. Stereo vision can be observed when the left and right eyes of the observer are positioned at respective viewing zones or regions, whose locations are defined by the specific configuration (e.g., dimensions, layouts, geometry, etc.) of the display with parallax barrier. Stereo vision cannot be observed when the eyes of the observer move away from the defined viewing zones.

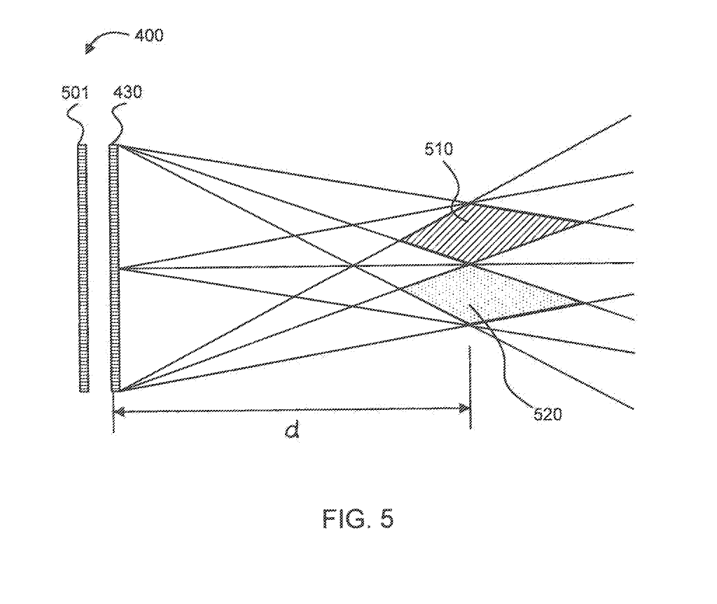

FIG. 5 is a diagram showing two viewing zones 510 and 520 associated with the display 400 of FIG. 4. With respect to each LCD pixel 501 of the display 400, parallax barrier 430 results in a left eye viewing region 520 and a right eye viewing region 510, within which the pixel appears as a left eye view and a right eye view, respectively. The left eye viewing region 520, which corresponds to the location 402 shown in FIG. 4, indicates that when the left eye of the observer stays within region 520, the left eye merely observes the left-eye images on the LCD display. Similarly, the right eye viewing region 510, which corresponds to the location 404 shown in FIG. 4, indicates that when the right eye of the observer stays within region 510, the right eye merely observes the right-eye images on the LCD display. It is to be noted that the viewing zones 510 and 520 are located at a predetermined viewing distance “d” from the display 400. However, when one or both eyes of the observer leave the extent of the respective viewing zones 510 and 520, no stereo vision is observed by the observer.

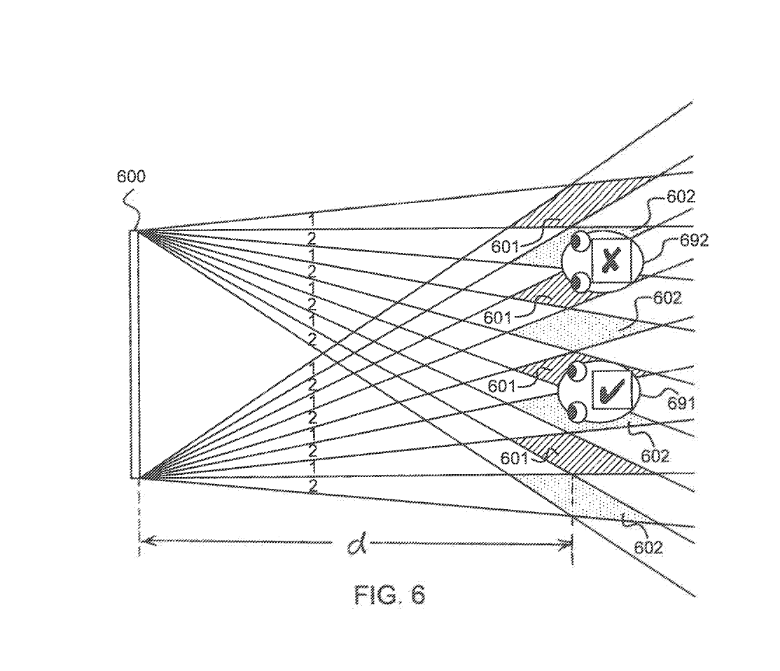

FIG. 6 shows a two-view three-dimensional display 600 to which the present principles can be applied, in accordance with an embodiment of the present principles. The two-view three-dimensional display 600 is shown with respect to two observers 691 and 692, and the use of a parallax barrier or lenticular display results in multiple viewing zones, with alternating views labeled as “1 ” and “2”, as shown in FIG. 6. In this and subsequent figures, each multi-view auto-stereoscopic display includes a parallax barrier similar to those in FIGS. 4-5 (or other suitable component for auto-stereoscopy such as lenticular lens), even though they are not shown explicitly in these figures.

In this configuration, the image in view 1 corresponds to a right-eye image and the image in view 2 corresponds to a left-eye image, and each of the diamond-shaped regions 601 and 602 in space corresponds to a viewing zone or region within which only a single image, i.e., view 1 or view 2 image, is visible.

As long as an observer has his/her left eye in a left eye viewing zone 602 and the right eye in a right eye viewing zone 601 (such as observer 691), the observer will see stereo vision. However, there is a 50% chance that the observer's head will be in the wrong place (such as observer 692), that is, seeing the left image with the right eye and vice versa. This gives a pseudo-scopic image, that is, inverted stereo. Therefore, the observer has to ensure that their eyes stay within the respective viewing zones, which can be difficult because of the relatively small areas or extents of the zones.

This problem can be overcome by increasing the number of views being displayed, giving each viewer some flexibility to move their head left and right beyond the respective right and left viewing zones 601 and 602.

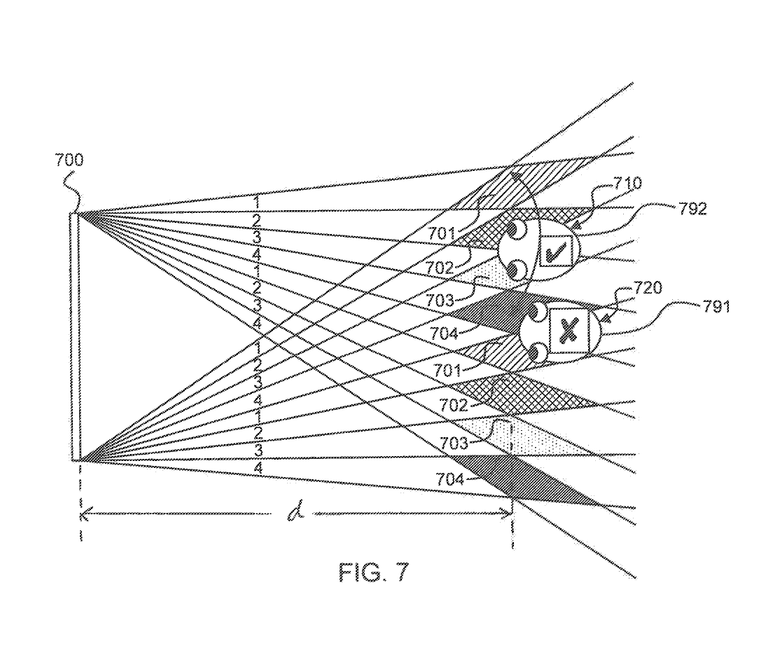

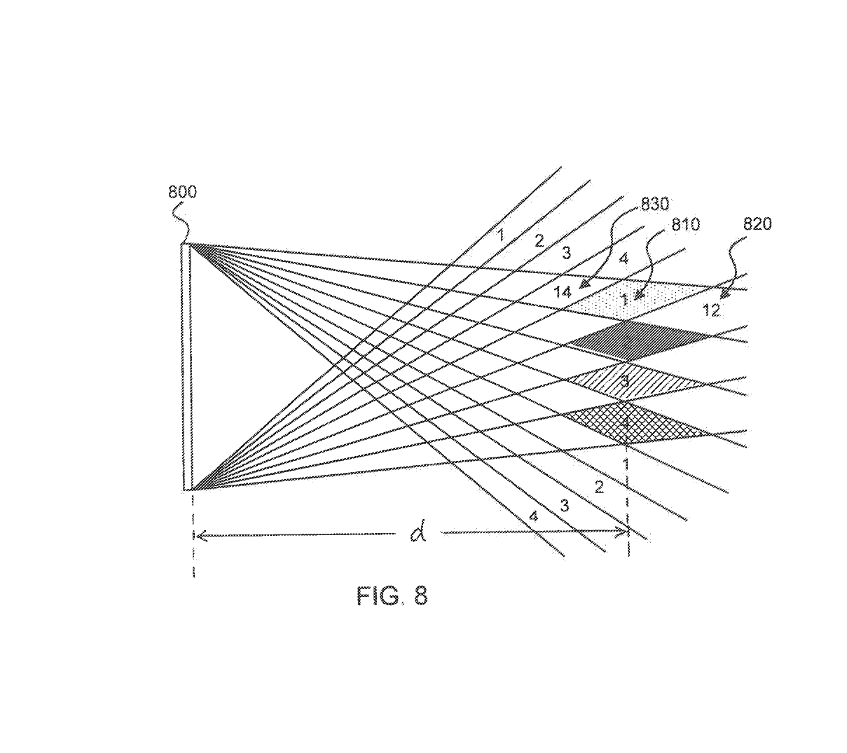

FIG. 7 shows viewing zones corresponding to a four-view three-dimensional display 700, in which the number of displayed views is increased from two views as in FIG. 6) to four views, in accordance with an embodiment of the present principles. Each of the four views is respectively labeled as 1 through 4. In this configuration, views 1-4 represent different viewpoints of a scene or image in a sequential order. Specifically, these views are provided such that adjacent images in the view sequence 1-4 (i.e., views 1 and 2; views 2 and 3; and views 3 and 4) correspond to images in a right- and left stereoscopic image pair. However, views 4 and 1 will not form aright- and left- stereoscopic image pair.

Thus, observer 792 at location 710 can see stereo vision because the right eye in zone 702 can see view 2, and the left eye in zone 703 can see view 3. Furthermore, stereo vision can be observed at two other locations, i.e., right and left eyes in adjacent zones 701 and 702 (views 1 and 2, respectively); and in zones 703 and 704 (views 3 and 4, respectively). Although there is still a chance of seeing a pseudoscopic image when the observer 791 is at location 720 (with the right eye seeing view 4 and the left eye seeing view 1), the chance is decreased to 25% due to the increased number of views compared to the scenario in FIG. 6.

However, even with this multi-view display with increased number of views, the optimal distance “d” of the respective viewing zones from the display is fixed, i.e., predetermined according to the design and configuration of the 3D display unit, which restricts the forward and backward movement of the observer with respect to the display. At the optimal distance, each eye in the correct viewing zone sees the whole screen showing exactly one view. As the observer moves forward or backward, the viewing distance changes from the optimal distance, and the observer may find that the image is made up of parts of different views.

This is illustrated in FIG, 8, which shows four views corresponding to different viewing locations with respect to a multi-view three-dimensional display 800 to which the present principles can be applied. If the observer's right eye is at location 810, the right eye will see only view 1. If the observer moves backward such that the observer's right eye is at location 820, then the right eye will see a mix of view 1 and view 2. If the observer moves forward such that the observer's right eye is at location 830, then the right eye will see a mix of view 1 and view 4. Thus, as the observer moves forward or backward from the optimal distance, the observer will see a mix of different views, with a lot of ghosting.

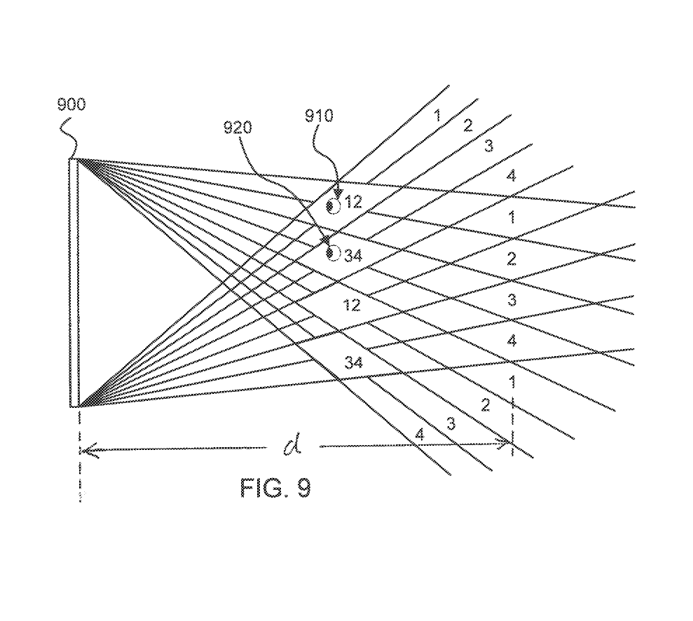

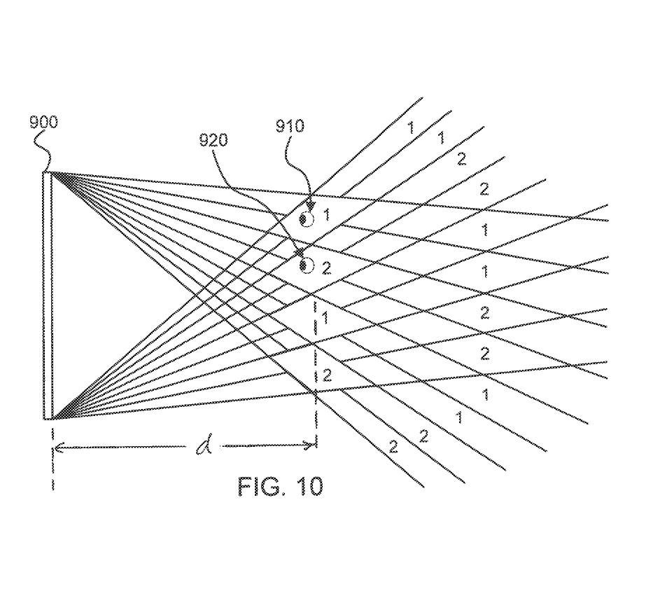

According to one embodiment of the present principles, the location of the observer, or alternatively, one or both eyes of the observer, is sensed or detected, such that when the observer is determined to be somewhere closer to the display than the optimal distance so as to result in at least one eye seeing more than one view, the multi-view display system will decrease the number of views (compared to the initial number) and replace the image of some views with that of other views so that the observer can still see a stereo vision. This is further discussed with reference to FIGS. 9-10 below.

FIG. 9 shows various views being displayed at different viewing locations with respect to a multi-view three-dimensional display 900 with position sensing, to which an embodiment of the present principles can be applied. In this example, the auto-stereoscopic display 900 is configured for displaying four views. When the right eye of the observer is at location 910 and the left eye of the observer is at location 920, the observer's right eye will see a mixed image of view 1 and view 2, and the observer's left will see a mixed image of view 3 and view 4. In other words, at these mixed-view zones, it will not be possible to observe stereo vision.

However, according to an embodiment of the present principles, the system (e.g., through its position sensing unit 210 of FIG. 2) will detect that the observer is located at a “wrong” or undesirable position with respect to an optimal viewing position at distance “d” from the display 900. The system then decreases the number of views from 4 to 2 and re-disposes or arranges the two displayed views (e.g., using view disposing unit 220 of FIG. 2) so that each view will occupy two neighboring or adjacent optical slots, as shown in FIG. 10. In this discussion, the term “optical slot” refers to a volume or spatial extent (defined by the multi-view auto-stereoscopic system) within which a single view can be provided or projected.

FIG. 10 shows the resulting views 1 and 2 (i.e., after the multi-view display has been re-configured from 4 display views to 2 display views) at the various viewing locations for the multi-view three-dimensional display 900, with same locations 910 and 920 as in FIG. 9. In this configuration, the observer's right eye at viewing zone or location 910 will see only view 1, and the observer's left eye at viewing zone or location 920 will see only view 2, such that proper stereo vision or a three-dimensional image can be observed.

Therefore, according to one embodiment, the multi-view image display system can adapt the number of displayed views according to the detected observer's position. By reducing the number of displayed views, locations of the viewing zones (or the corresponding sweet spots) for stereo vision can be adapted or changed based on the observer's position, resulting in additional freedom for the observer to move left/right and forward/backward as compared to the prior art.

In FIG. 10, the number of views is reduced to half of the original or initial number of views being displayed (that is, from four views to two views) and all of the views occupy the same number of optical slots. In this example, view 1 and view 2 each occupies two adjacent optical slots, such that viewing zones 910 and 920 will each show only one view. In this adjusted or adapted multi-view configuration, the optimal distance for stereovision viewing is also changed to the location of the observer (i.e., different from the optimal distance in FIG. 9). This “reduced-view” arrangement can be implemented at specific locations in accordance with the specific configuration of the autostereoscopic display.

It should be noted that it is possible to reduce the number of views to any number greater than or equal to two (in order to provide stereovision), and that different views may occupy different numbers of optical slots. In one embodiment, at least one view in the reduced-view configuration is arranged to occupy at least two adjacent optical slots, such that the extent of the corresponding viewing zone (i.e., associated with the two adjacent slots) will be enlarged or increased compared to that in the initial view configuration. For example, if the display is reduced from 4 views to 3 views, view 1 can occupy 2 adjacent slots, while views 2 and 3 can each occupy one slot. In this case, the viewing zone for view 1 will be larger in extent compared to the viewing zone in the 4-view configuration (which has only one slot per view). Furthermore, the viewing zone for view 1 will also be larger than the respective viewing zones for views 2 and 3 in the new 3-view configuration.

It is also possible to have each of views 1-3 occupy only one slot, in which case, the extents of the viewing zones for all views will be equal. In another embodiment, the autostereoscopic display system can also be configured to provide adjustable optical slots. The specific arrangement of the views versus the number of optical slots can be selected or determined based on principles of autostereoscopic displays, such as those in “Broadcast 3D and Mobile Glasses-free Displays” from selected content from Insight Media Univeristy courses, among others.

In another example, for a 16-view display, the system may decide to decrease the number of views from 16 to 6 according to the position of the observer. This can give rise to the following scenarios or situations of slot allocations for the 6 views.

Possible Situations

| | Observer's | Observer's | | | | | | |
|---|---|---|---|---|---|---|---|---|
| | current | new | View 1 | View 2 | View 3 | View 4 | View 5 | View 6 |
| | position | position | (optical | (optical | (optical | (optical | (optical | (optical |
| NO. | (views) | (views) | slot #) | slot #) | slot #) | slot #) | slot #) | slot #) |
| 1 | 1, 2 | 3, 4 | 3 | 3 | 3 | 3 | 2 | 2 |
| 2 | 1, 2 | 5, 6 | 3 | 3 | 2 | 2 | 3 | 3 |
| 3 | 3, 4 | 5, 6 | 2 | 2 | 3 | 3 | 3 | 3 |
| 4 | 3, 4 | 1, 2 | 3 | 3 | 3 | 3 | 2 | 2 |
| 5 | 5, 6 | 1, 2 | 3 | 3 | 2 | 2 | 3 | 3 |
| 6 | 5, 6 | 3, 4 | 2 | 2 | 3 | 3 | 3 | 3 |

For this view arrangement, two views for an observer's current position (i.e., for the right and left eye views), as well as two views for another position (e.g., adjacent to the current position) can each occupy three optical slots, while the remaining two views can occupy two slots. Each slot allocation scenario (i.e., No. 1-6) is assigned by the system according to the observers current position and new position. The new position can be estimated, for example, by using motion detection of the observer. When the system has determined the current position and the estimated new position, the slot allocation can be adjusted accordingly.

As an example, when an observer is initially at a position corresponding to views 3 and 4, the display system can configure each of views 3 and 4 to occupy 3 optical slots. Suppose the system detects that the observer is moving to a new position corresponding to views 5 and 6, the display system can adjust the slot allocations to scenario No. 3, and assign 3 optical slots to each of views 5 and 6, with the remaining views 1 and 2 each also occupying 2 optical slots. In other words, the display system implements the optical slot allocation as a dynamic process (e.g., in real-time) according to the observer's position and movement.

The present principles for a multi-view three-dimensional system and method with position sensing and adaptive number of views can be implemented in a three-dimensional display device such as an auto-stereoscopic three-dimensional display, or in video playback devices that are coupled to a three-dimensional display device. In one embodiment, the present principles are configured for multi-user configurations such as in a home environment. However, in other embodiments, the present principles can be implemented in mobile devices with three-dimensional screens.

In one embodiment, the number of displayed views is reduced to the minimum number of views necessary to ensure that each eye is seeing a different view. This can be implemented for more than one viewer, with certain limitations depending on the number of views, view positions, and so forth.

All statements herein reciting principles, aspects, and embodiments of the present principles, as well as specific examples thereof, are intended to encompass both structural and functional equivalents thereof. It is also intended that such equivalents include both currently known equivalents as well as equivalents developed in the future, i.e., any elements developed that perform the same function, regardless of structure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Preferably, the teachings of the present principles are implemented as a combination of hardware and software. The software may be implemented as an application program tangibly embodied on a program storage unit or computer readable storage medium. The application program may be uploaded to, and executed by, a machine comprising any suitable architecture. Preferably, the machine is implemented on a computer platform having hardware such as one or more central processing units (“CPU”), RAM, and input/output interfaces.

Although the illustrative embodiments have been described herein with reference to the accompanying drawings, it is to be understood that the present principles is not limited to those precise embodiments, and that various changes and modifications may be effected therein by one of ordinary skill in the pertinent art. All such changes and modifications are intended to be included within the scope of the present principles as set forth in the appended claims.

1. A multi-view three-dimensional display system with an adaptive number of views, comprising:
a position sensing unit (210) for detecting a position of an observer;
a view disposing unit (220) for determining a number of views and a view arrangement based on the position, such that only a different one of the views is provided to a viewing zone for each eye of the observer; and
a multi-view display unit (230) for displaying the number of views according to the view arrangement determined by the view disposing unit to enable viewing of a three-dimensional image by the observer.

2. The system of claim 1, wherein the view disposing unit is configured to increase the number of views compared to an initial number of views being displayed, if the detected position corresponds to one at which only one view of an image is provided to each eye.

3. The system of claim 1, wherein the view disposing unit is configured to decrease the number of views compared to an initial number of views being displayed, if the detected position corresponds to one at which each eye observes more than one view of the image.

4. The system of claim 1, wherein the position sensing unit (210) comprises:
an observer image generation unit (211) for generating an image of the observer; and
a position calculating unit (212) for calculating the position from the image of the observer.

5. The system of claim 3, wherein the observer image generation unit (211) comprises at least one of a monocular camera, a stereo camera, a multi-camera, and a depth camera.

6. The system of claim 1, wherein the position sensing unit (210) comprises a distance measuring unit (213) to measure a respective distance of at least one of the observer and at least one eye of the observer, from the multi-view display unit (230).

7. The system of claim 1, wherein the position sensing unit (210) senses the respective position of each of the left eye and the right eye of the observer, and the view disposing unit (220) computes the number of views and the view arrangement responsive to the respective position of each of the left eye and the right eye of the observer.

8. The system of claim 1, wherein the view disposing unit (220) computes the number of views and the view arrangement to enlarge respective viewing zones associated with the left and right eyes of the observer.

9. The system of claim 1, wherein the view arrangement includes at least two different views.

10. The system of claim 1, wherein the multi-view display unit (230) displays the resultant three-dimensional image using at least one of a lenticular lens, a parallax barrier, a prism arrangement, multi-projectors, a holographic device having characteristics to convert a direction of light, and a directional backlight.

11. A method for displaying multi-view three-dimensional content, comprising:
detecting (310) a position of an observer;
determining (320) a number of views and a view arrangement based on the position such that only a different one of the views is provided to a viewing zone for each eye of the observer; and
displaying (330) the number of views in accordance with the view arrangement to enable viewing of a three-dimensional image by the observer.

12. The method of claim 11, wherein the determining step includes increasing the number of views compared to an initial number of views being displayed, if the detected position corresponds to one at which only one view of an image is provided to each eye.

13. The method of claim 11, wherein the determining step includes decreasing the number of views compared to an initial number of views being displayed, if the detected position corresponds to one at which each eye observes more than one view of the image.

14. The method of claim 11, wherein the sensing step (310) comprises:
generating an image of the observer; and
calculating the position from the image of the observer.

15. The method of claim 14, wherein the image of the observer is generated using at least one of a monocular camera, a stereo camera, a multi-camera, and a depth camera.

16. The method of claim 11, wherein the sensing step (310) comprises measuring a respective distance of at least one of, the observer and the least one eye of the observer, from the multi-view display unit.

17. The method of claim 11, wherein the sensing step (310) senses the respective position of each of the left eye and the right eye of the observer, and the computing step (320) computes the number of views and the view arrangement responsive to the respective position of each of the left eye and the right eye of the observer.

18. The method of claim 11, wherein the computing step (320) computes the number of views and the view arrangement to enlarge respective viewing zones associated with the left and right eyes of the observer.

19. The method of claim 11, wherein the view arrangement includes at least two different views.

20. The method of claim 11, wherein the displaying step (330) displays the resultant three-dimensional image using at least one of a lenticular lens, a parallax barrier, a prism arrangement, multi-projectors, a holographic device having characteristics to convert a direction of light, and a directional backlight.

21. A computer readable storage medium comprising a computer readable program for use in a multi-view three-dimensional display system, wherein the computer readable program when executed by a computer causes the computer to perform the following steps:
detecting a position of an observer;
determining a number of views and a view arrangement based on the detected position such that only a different one of the views is provided to a viewing zone for each eye of the observer; and
displaying the number of views in accordance with the view arrangement to enable viewing of a three-dimensional image by the observer.

22. The computer readable storage medium of claim 21, wherein the determining step includes increasing the number of views compared to an initial number of views being displayed, if the detected position corresponds to one at which only one view of an image is provided to each eye.

23. The computer readable storage medium of claim 21, wherein the determining step includes decreasing the number of views compared to an initial number of views being displayed, if the detected position corresponds to one at which each eye observes more than one view of the image.

24. The computer readable storage medium of claim 21, wherein the detecting step comprises:
generating an image of the observer; and
calculating the position from the image of the observer.

25. The computer readable storage medium of claim 21, wherein the detecting step comprises measuring a respective distance of at least one of: the observer and at least one eye of the observer, from the multi-view display unit.

26. The computer readable storage medium of claim 21, wherein the computing step computes the number of views and the view arrangement to enlarge respective viewing regions associated with the left and right eyes of the observer.
